(19) United States
(12) Patent Application Publication
(10) Pub. No.: US 2022/0220285 A1
(43) Pub. Date: Jul. 14, 2022

(54) METHOD FOR MANUFACTURING A SUSPENSION OF CELLULOSE NANOFIBRILS

(71) Applicants: INSTITUT POLYTECHNIQUE DE GRENOBLE, Grenoble (FR); CENTRE TECHNIQUE DU PAPIER, Gieres (FR); CENTRE NATIONAL DE LA RECHERCHE SCIENTIFIQUE, Paris Cedex 16 (FR); UNIVERSITE GRENOBLE ALPES, Saint Martin d'Hères (FR)

(72) Inventors: Julien BRAS, Saint Martin d'Uriage (FR); Fleur ROL, Camaret-sur-Aigues (FR); Michel PETIT-CONIL, Grenoble (FR); Valérie MEYER, Saint Martin d'Hères (FR)

(21) Appl. No.: 17/608,057

(22) PCT Filed: May 4, 2020
(86) PCT No.: PCT/EP2020/062284

§ 371 Date: Nov. 1, 2021

(30) Foreign Application Priority Data
May 2, 2019 (FR) 1904639

(51) Int. Cl. C08L 1/04

(52) U.S. Cl. CPC C08L 1/04

(57) ABSTRACT

A method for manufacturing a suspension of cellulose nanofibrils from an aqueous suspension of cellulose fibres is disclosed including the following steps: chemical treatment, in a reactor, of the aqueous suspension of cellulose fibres by at least one functionalising agent, the chemical treatment being configured to functionalise the cellulose fibres at a modification rate that is higher, indeed strictly higher, than 1.0 mmol/g, and mechanical treatment, in a twin-screw extruder, of the aqueous suspension of functionalised cellulose fibres, each screw of the extruder comprising at least two fibrillation segments. In accordance with at least one embodiment, this method makes it possible to produce a suspension of cellulose nanofibrils of good quality, with a high dry matter content, and while consuming less energy than the methods of the prior art.

### TECHNICAL FIELD

The invention relates to the field of the production of a suspension of cellulose micro/nanofibrils from an aqueous suspension of cellulose fibres. It has particularly advantageous applications in the fields of packaging, paint, paper or medicine.

### PRIOR ART

Cellulose is the most abundant polymer on Earth and has solid advantages for replacing products of fossil origin. Indeed, it is a biosourced, renewable, sustainable and biocompatible material. At the nanometric scale, cellulose fibres have additional properties that make them very attractive. Films of cellulose nanofibrils or of cellulose microfibrils (CNF for “cellulose nanofibers” and MFC for “microfibrillated cellulose”) are transparent and have high mechanical properties. CNFs also have barrier properties such as a barrier against grease, oxygen, aromas or contaminants. Industrial production of CNF began in 2011, but the quantities produced are still low due the cost of manufacture (high energy consumption, cost of the raw material, chemicals) and also due to the cost of transport (due to the low concentration in dry matter of the suspensions produced). Indeed, suspensions of cellulose micro/nanofibrils are currently produced at a concentration comprised between 2% and 5% in dry matter, or 98% to 95% in water. Suspensions at 2% behave as a gel and it is very difficult to remove the water from them. Therefore, most of the material transported is water, creating storage problems by the same occasion.

Cellulose micro/nanofibrils are often produced via an enzymatic or chemical pre-treatment of the cellulose fibres followed by a mechanical treatment making it possible to isolate the micro/nanofibrils. A chemical or enzymatic pre-treatment is necessary to weaken the hydrogen bonds between the fibres by modifying the OH groups and thus facilitate the separation of the CNFs. According to the pre-treatment used, it is possible to obtain CNFs of different qualities. Chemical pre-treatments make it possible to produce CNFs of better quality and smaller. Many studies have been conducted on the chemical modification of cellulose for nanofibrillation, as recently described by Rol et al. (Rol, F.; Belgacem, M. N.; Gandini, A.; Bras, J. Recent Advances in Surface-Modified Cellulose Nanofibrils. Prog. Polym. Sci. 2018). TEMPO oxidation (Isogai, A.; Saito, T.; Fukuzumi, H. TEMPO-Oxidized Cellulose Nanofibers. Nanoscale 2011, 3 (1), 71-85), carboxymethylation (Naderi, A.; Lindström, T.; Sundström, J. Carboxymethylated Nanofibrillated Cellulose: Rheological Studies. Cellulose 2014, 21 (3), 1561-1571) and cationisation (Saini, S.; Yücel Falco, Ç.; Belgacem, M. N.; Bras, J. Surface Cationized Cellulose Nanofibrils for the Production of Contact Active Antimicrobial Surfaces. Carbohydr. Polym. 2016, 135, 239-247) are the most used pre-treatments. Chemical pre-treatments of cellulose lead to functionalised CNFs that make it possible to use these CNFs for later modification and which have additional properties. For example, it is known that cationic CNFs have antimicrobial properties, while phosphorylated CNFs (Ghanadpour, M.; Carosio, F.; Larsson, P. T.; Wågberg, L. Phosphorylated Cellulose Nanofibrils: A Renewable Nanomaterial for the Preparation of Intrinsically Flame-Retardant Materials. Biomacromolecules 2015, 16 (10), 3399-3410) have flame-retardant properties.

Functionalised CNFs can also be produced via a periodate oxidation. Periodate oxidation creates aldehyde groups on the cellulose fibres, which makes it possible to improve the nanofibrillation and to graft other molecules. For example, Larsson et al. (Larsson, P. A.; Berglund, L. A.; Wågberg, L. Highly Ductile Fibres and Sheets by Core-Shell Structuring of the Cellulose Nanofibrils. Cellulose 2013, 21 (1), 323-333) isolated the CNFs after periodate oxidation and sodium borohydride reduction. CNFs of good quality can also be produced after a periodate oxidation followed by a chlorite oxidation (Liimatainen, H.; Visanko, M.; Sirviö, J. A.; Hormi, O. E. O.; Niinimaki, J. Enhancement of the Nanofibrillation of Wood Cellulose through Sequential Periodate-Chlorite Oxidation. Biomacromolecules 2012, 13 (5), 1592-1597). Sirvio et al. (Sirviö, J. A.; Anttila, A.-K.; Pirttilä, A. M.; Liimatainen, H.; Kilpeläinen, I.; Niinimäki, J.; Hormi, O. Cationic Wood Cellulose Films with High Strength and Bacterial Anti-Adhesive Properties. Cellulose 2014, 21 (5), 3573-3583) have produced cationic CNFs by periodate oxidation, then by reaction with the Girard's reagent. Thus, periodate oxidation has recently been developed for the nanofibrillation of cellulose fibres and makes it possible to produce CNFs of high quality. However, the industrialisation of this method does not seem to be realistic due to the duration of the process (several days) and the toxic products used.

Ozone also makes it possible to create carbonyl groups on the cellulose fibres and appears to be a better industrial option. Indeed, ozone is inexpensive, non-toxic, available on a large scale and is already used to whiten paper pulp. Patent document US 2015/0167243 A1 proposes an evolutive energy efficient method for preparing cellulose nanofibres that uses a mixture of ozone and enzyme. A reduction in the degree of polymerisation of the cellulose and a decrease in the energy consumption by at least 8% have been reported. Another patent document WO 2014/029909 discloses that the primary wall of cellulose fibres can also be eliminated by ozonation before the nanofibrillation in a homogeniser or a microfluidizer. It is also known, from patent document U.S. Pat. No. 7,700,764 B2, a method for producing microfibrillar polysaccharide such as cellulose using an oxidiser (0.1 to 5% by weight) in the form of ozone or hydrogen peroxide and a transition metal such as iron (up to 20% by weight based on the weight of the oxidiser). More recently, Beheshti Tabar et al. (Beheshti Tabar, I.; Zhang, X.; Youngblood, J. P.; Mosier, N. S. Production of Cellulose Nanofibers Using Phenolic Enhanced Surface Oxidation. Carbohydr. Polym. 2017, 174, 120-127) have isolated the CNFs by using an enzyme and ozone in the presence of lignin-derived phenolic compounds in order to create carbonyl groups on the cellulose fibres. The ozone thus appears as a new encouraging pre-treatment, that can be carried out industrially. The reaction can be done at room temperature, with a high dry fibre content and does not involve any toxic product.

Moreover, it has recently been suggested to use, to produce cellulose nanofibrils with a high dry fibre content and with an optimum energy efficiency a twin-screw extruder (Cf. in particular patent document WO 2011/051882 (A1)). Ho et al. (Ho, T. T. T.; Abe, K.; Zimmermann, T.; Yano, H. Nanofibrillation of Pulp Fibers by Twin-Screw Extrusion. Cellulose 2014, 22 (1), 421-433) were the first to produce CNFs with a dry matter content comprised between 33 and 45% by weight from non-treated fibres by using a combination of conveyor screws and mixing elements. More recently, Rol et al. (Rol, F.; Karakashov, B.; Nechyporchuk, O.; Terrien, M.; Meyer, V.; Dufresne, A.; Belgacem, M. N.; Bras, J. Pilot Scale Twin Screw Extrusion and Chemical Pretreatment as an Energy Efficient Method for the Production of Nanofibrillated Cellulose at High Solid Content. ACS Sustain. Chem. Eng. 2017) have shown that the energy can be reduced by 63% by using a twin-screw extruder instead of an ultrafine grinder without degrading the quality of the CNFs produced. Finally, Baati et al. (Baati, R.; Magnin, A.; Boufi, S. High Solid Content Production of Nanofibrillar Cellulose via Continuous Extrusion. ACS Sustain. Chem. Eng. 2017) have reported a low energy consumption to produce TEMPO CNFs using a conical micro-extruder.

Document JP 2017025123 A discloses a method for obtaining a suspension of cellulose nanofibrils comprising a chemical treatment of an aqueous suspension of cellulose fibres, a drying of the chemically-treated cellulose fibres, a suspension of these fibres in hot water, then a dispersion by mechanical treatment of these fibres. This method remains however complex to implement, and the drying followed by a re-suspension is costly in energy and limits the quality of the suspension of CNF produced.

However, there is still a need to optimise the production of CNF.

An object of the present invention is therefore to propose an optimised method of producing a suspension of cellulose micro/nanofibrils from an aqueous suspension of cellulose fibres.

Another object of the present invention is to propose a method that makes it possible to produce cellulose micro/nanofibrils of quality, with a high dry matter content, while consuming little energy. Producing more concentrated suspensions of CNF/CMF would limit the cost of transport, while still expanding the scope of applications. Indeed, for certain applications, the presence of water in a large quantity and the “freezing” behaviour of the suspension can be a hindrance.

A method for production is also sought that furthermore uses products that are hardly toxic and inexpensive.

The other objects, characteristics and advantages of the present invention shall appear when examining the following description and the accompanying drawings. It is understood that other advantages can be incorporated.

### SUMMARY

To achieve this objective, according to an embodiment, the present invention provides a method of manufacturing a suspension of cellulose micro/nanofibrils from an aqueous suspension of cellulose fibres comprising the following steps:
chemical treatment of the aqueous suspension of cellulose fibres by at least one functionalising agent, the chemical treatment being configured to functionalise the cellulose fibres at a higher modification rate, indeed strictly higher, than 1.0 mmol/g, and
mechanical treatment, by a twin-screw extruder, of the aqueous suspension of cellulose fibres, each screw of the extruder comprising at least two fibrillation segments (mixing).

The functionalising agent comprises, preferably is constituted, of ozone.

The method combines at least two treatments, a chemical treatment and a mechanical treatment, to produce cellulose micro/nanofibrils.

The optimisation of this method is based on the combination:
of a minimum modification rate obtained by chemical treatment aimed at weakening the hydrogen bonds between the cellulose microfibrils and within each cellulose fibre between their fibrils and
of the use of a twin-screw extruder each screw of which comprises at least two fibrillation segments.

This optimised method makes it possible to produce a suspension of cellulose micro/nanofibrils of good quality, with a high dry matter content (the concentration in dry matter of the suspension obtained, thanks to the method according to the invention, is multiplied by 10 with respect to the existing industrial methods) and while consuming less energy than the methods of the prior art (a reduction in energy consumption comprised between 5 and 70% is advantageously obtained thanks to the method according to the invention).

In order to obtain the abovementioned advantages, advantageously a single pass, even a maximum of two passes, of the aqueous suspension of functionalised cellulose fibres in the twin-screw extruder can be, even is, required and sufficient.

This method can be optimised further according to some of the characteristics mentioned hereinbelow, taken individually or in combination. In particular, as indicated hereinbelow, certain combinations of these characteristics, for example certain combinations of two of these characteristics, allow for an optimisation that extends beyond the juxtaposition of their individual effect, by synergy between these characteristics.

Before beginning a detailed review of the embodiments of the invention, optional characteristics that can possibly be used in association or alternatively are mentioned hereinafter:
the chemical treatment can be configured to functionalise the cellulose fibres with a modification rate higher than 1.3 mmol/g;
the chemical treatment can be configured to functionalise the cellulose fibres with a modification rate less than 3.0 mmol/g;
the chemical treatment can be configured to functionalise the cellulose fibres at a modification rate comprised between 1.0 mmol/g and 3.0 mmol/g, preferably comprised between 1.3 mmol/g and 2.1 mmol/g;
each screw of the extruder can comprise between 2 and 6, preferably between 3 and 5, fibrillation segments. The method according to these last two technical characteristics makes it possible to produce a suspension of cellulose micro/nanofibrils of quality, with a high concentration in dry matter, and while consuming little energy. More particularly, these last two technical characteristics when they are combined with one another, in particular in their preferred embodiment, have a synergistic effect that makes it possible to achieve a level of optimisation that goes beyond the sum of the levels of optimisation that these technical characteristics make it possible to achieve when they are considered separately from one another;
the aqueous suspension of functionalised cellulose fibres has a concentration comprised between 10 and 30%, preferably comprised between 10 and 20%, and even more preferably substantially equal to 20%, by weight of dry matter at the inlet of the twin-screw extruder;
the suspension of cellulose micro/nanofibrils obtained has a concentration comprised between 10 and 30%, preferably comprised between 10 and 20%, and even more preferably substantially equal to 20%, by weight of dry matter;
the mechanical treatment can comprise at most two passes, preferably a single pass, of the aqueous suspension of functionalised cellulose fibres in the twin-screw extruder;
the chemical treatment can be followed by and the mechanical treatment can be preceded by a step chosen from a step of concentrating or a step of diluting the aqueous suspension of functionalised cellulose fibres, this step being configured in such a way as to obtain a concentration of the aqueous suspension of functionalised cellulose fibres comprised between 10 and 30%, preferably comprised between 10 and 20%, and even more preferably substantially equal to 20%, by weight of dry matter at the inlet of the twin-screw extruder. The method according to this characteristic allows both:
   to obtain a satisfactory transit of the material through the twin-screw extruder, in particular by causing little overheating of the material and by preventing any risk of blocking of the material, during the transit thereof in the extruder, and
   to obtain at the outlet of the twin-screw extruder a satisfactory concentration in dry matter, in particular in terms of transport efficiency, but also in terms of possibilities of industrial post-treatment.
   Thus, an optimised compromise is advantageously reached;
the chemical treatment can be followed by and the mechanical treatment can be preceded by a step of washing the aqueous suspension of cellulose fibres, the step of washing being configured in such a way as to remove residues of the functionalising agent from the aqueous suspension of functionalised cellulose fibres;
the step of washing can precede the step chosen from a step of concentrating or a step of diluting;
at least two fibrillation segments, preferably at least three fibrillation segments, of each screw of the extruder bi-vis can be configured to generate shearing rates and cumulated deformations that are different from one another, preferably the shearing rates are different from one another by a factor higher than or equal to 2;
each screw of the extruder can comprise a conveyor segment on at least one side of each fibrillation segment, preferably on either side of each fibrillation segment, preferably each conveyor segment having a direct screw thread and each fibrillation segment having a reverse screw thread;
each fibrillation segment can be configured to induce, on the material in transit in the twin-screw extruder, a deformation that is substantially ten times higher than the deformation induced by a conveyor segment;
at least one fibrillation segment, preferably each fibrillation segment, of at least one of the two screws can comprise at least one, even only one, among a portion with a direct screw thread and a portion with a reverse screw thread;
the two screws of the twin-screw extruder are identical to each other;
the mechanical treatment can be carried out at a temperature comprised between 0 and 20° C.;
the mechanical treatment can be carried out with a rotation speed of the screws comprised between 100 and 500 rpm;
the mechanical treatment is preferably free of any adding of chemical agents;
ozone can be added, even mixed with the aqueous suspension of cellulose fibres at a concentration comprised between 10 and 35%, preferably comprised between 10 and 15%, of the weight in dry matter of cellulose, the modification rate being higher than 1.2 mmol/g, preferably higher than 1.3 mmol/g;
the chemical treatment with ozone can be carried out in the presence of a catalyst comprising an iron salt, preferably an iron sulphate, at a concentration comprised between 0.01 and 5%, preferably comprised between 0.02 and 3% by weight of the weight in dry matter of cellulose. The modification rate is thus advantageously increased;
before the chemical treatment, the aqueous suspension of cellulose fibres can have a concentration substantially equal to 40% in dry matter;
furthermore, the method can comprise, before the chemical treatment, a chemical pre-treatment comprising the mixing of the aqueous suspension of cellulose fibres with an acid, preferably a sulphuric acid. The chemical pre-treatment can be configured in such a way that the aqueous suspension of cellulose fibres has a pH strictly less than 4, preferably comprised between 3.2 and 3.3;
the step of chemical treatment can precede the step of mechanical treatment and be carried out in a reactor, the cellulose fibres being functionalised before the step of mechanical treatment.

### BRIEF DESCRIPTION OF THE FIGURES

The purposes and objects as well as the characteristics and advantages of the invention shall appear better in the detailed description of an embodiment of the latter which is shown in the following accompanying drawings wherein:

FIG. 1 shows a flowchart of the method according to an embodiment of the invention;

FIG. 2 shows a front view of the two screws, juxtaposed between them, of the twin-screw extruder implemented according to an preferred embodiment of the method according to the invention;

FIG. 3 shows a front view of one of the two screws shown in FIG. 2; and

FIGS. 4A to 4C show enlargements of the various fibrillation segments of the screw shown in FIG. 3.

The drawings are given as examples and do not limit the invention. They form schematic block diagrams intended to facilitate the understanding of the invention and are not necessarily to the scale of the practical applications.

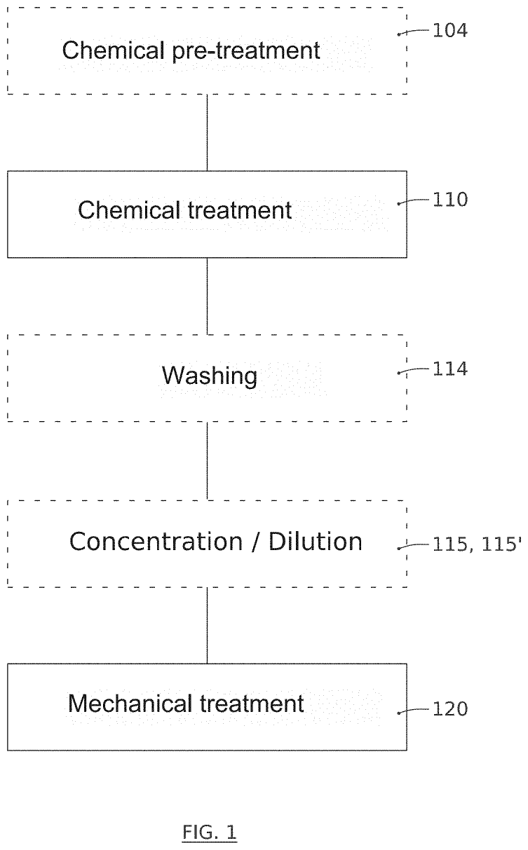

In FIG. 1, the steps of the method framed by dotted lines can be only optional.

### DETAILED DESCRIPTION

The term “cellulose” or “cellulose fibres” means a polysaccharide that forms the main constituent of the cell wall of the plant tissues and that participates in their support and in their rigidity. The cellulose comes from wood (which forms the main source of it), cotton (of which the fibres are almost pure cellulose), flax, hemp and other plants. It is also a constituent of several algae and a few fungi.

The term “cellulose micro/nanofibrils” or “micro/nanocellulose” means a heterogenous nanomaterial comprised of elements of a micrometric size (fragments of fibres) and of at least 50% by number in nano-objects (i.e. objects of which at least one of the dimensions is located between 1 and 100 nanometres). This nanomaterial has the form of a collection of isolated cellulose micro/nanofibrils or of beams of micro/nanofibrils derived from a cellulosic raw material, from cellulose or from cellulose fibres. There are many synonyms widely used for cellulose micro/nanofibrils: nanofibrillated cellulose (NFC or CNF for “Cellulose NanoFibrils”), microfibrillar cellulose, nanofibrillar cellulose, nanofibre cellulose, microfibrillated cellulose (MFC or CMF for “Cellulose MicroFibrils”), cellulose microfibre or cellulose microfibrils. The terms “cellulose micro/nanofibrils” or “micro/nanocellulose” here encompass all or any of these synonyms. Cellulose micro/nanofibrils have at least one dimension defined on the nanometric scale. They generally have a diameter of a few nanometres, typically comprised between 10 and 60 nm, and have a length of a few micrometres, typically comprised between 500 and 5000 nm. For example, cellulose nanofibrils form a material intended to be used, due to its very high rigidity, as a reinforcement in the matrix of several composites.

The term “modification rate” means a percentage of biological material or of added or modified chemical groups in relation to the initial chemical groups, immobilised on a support, in particular by a covalent bond. According to an embodiment of the invention, the grafted material can include carbonyls (of which aldehydes and/or ketones) and the support can include a cellulose fibre.

The term “twin-screw extruder” means an extruder provided with two co-penetrating screws, even inter-penetrating and co-rotative, mounted parallel in a sheath. The method of extrusion consists of continuously manufacturing finished products or semi-products, or of transforming materials, within a screw/sheath system. The term single-screw extrusion is used when there is a single screw, rotating within a cylindrical sheath and the term twin-screw extrusion bi-vis is used when two screws are involved, generally parallel, rotating inside a sheath the section of which has the shape of an eight.

There are two major families of twin-screw extruders: co-rotative extruders and counter-rotating extruders. In the case of the present invention, the twin-screw extruder belongs to the family of co-rotative extruders the screws of which have the same direction of rotation. In the case of the present invention, the twin-screw extruder comprises more particularly two inter-penetrated screws. This geometry defines, on each screw, “C” shaped chambers that are quasi-independent and limits to the maximum the exchanges of material between the different chambers. The term “fibrillation segment” means a segment of a screw of the twin-screw extruder configured with mixing elements in order to continuously manufacture finished products or semi-products, or to transform materials, within a screw/sheath system, by imposing shearing forces on the material transiting around this segment in the sheath.

The term “conveyor segment” means a segment of a screw of the twin-screw extruder configured with conveyor elements to transit the material in the sheath according to a direction oriented from the inlet to the outlet of the twin-screw extruder.

The term “a portion or a sub-segment with a direct screw thread” means a portion or a sub-segment of a fibrillation segment of a screw of the twin-screw extruder configured to favour the conveyance of the material transported in the twin-screw extruder to the outlet of the twin-screw extruder.

The term “a portion or a sub-segment with a reverse screw thread” means a portion or a sub-segment of a fibrillation segment of a screw of the twin-screw extruder configured to favour the conveyance of the material transported in the twin-screw extruder to the inlet of the twin-screw extruder.

Each fibrillation segment, as well as each portion or sub-segment of a fibrillation segment, can be comprised of a plurality of elements, conveyor elements or treatment elements such as mixing discs, juxtaposed together along the longitudinal axis of the screw to which they belong. Among others, the angular configuration of the discs together defines the shearing rate induced on the material in transit within the segment, the portion of the segment or the sub-segment.

The term “deformation” of the material in transit in the twin-screw extruder means a measurement consisting of multiplying the local shearing rate of a disc or of a segment of the twin-screw extruder by the residence time of the material in this disc or this segment.

The terms “less than” and “higher than” mean “less than or equal to” and “higher than or equal to”, respectively. Equality is excluded by the use of the terms “strictly less than” and “strictly higher than”. Also, the expressions of the type “equal, less than, higher than” imply comparisons that can accommodate certain tolerances, in particular according to the scale of magnitude of the values compared and the measurement uncertainties. Substantially equal, less than or higher than values fall within the scope of the interpretation of the invention.

A parameter that is “substantially equal/higher than/less than” a given value means that this parameter is equal/higher than/less than the given value, by plus or minus 20%, even 10%, close to this value. A parameter that is “substantially comprised between” two given values means that this parameter is at least equal to the smaller given value, by plus or minus 20%, even 10%, close to this value, and at most equal to the larger given value, by plus or minus 20%, even 10%, close to this value.

The present invention relates to a method for manufacturing, and more particularly a method for industrial production, of cellulose micro/nanofibrils by a specific chemical treatment, followed by a mechanical treatment by a twin-screw extruder. More particularly, the method of manufacturing 100 according to the invention makes it possible to manufacture a suspension of cellulose micro/nanofibrils from an aqueous suspension of cellulose fibres.

In its broadest sense, and in reference to FIG. 1, the method comprises a step of chemical treatment 110, in a reactor, of the aqueous suspension of cellulose fibres and a step of mechanical treatment 120 of the aqueous suspension of functionalised cellulose fibres.

The chemical treatment 110 is carried out by at least one functionalising agent and configured in such a way as to functionalise the cellulose fibres with a higher modification rate, indeed strictly higher, than 1.0 mmol/g, and preferably higher than 1.3 mmol/g. The functionalising agent can comprise, or be constituted, of ozone. Moreover, the chemical treatment 110 can be configured in such a way that the modification rate remains less than 2.0 mmol/g, preferably less than 1.9 mmol/g. When the functionalising of the fibres consists of grafting aldehydes thereon, preferably with ketones, the contents in aldehydes can be measured by the copper index method according to the standard NF T 2-004.

Industrially, several reactors can be implemented so as to be able to continuously supply one or more twin-screw extruders, by switching from one reactor to the other the supply of the extruders with aqueous suspension of functionalised cellulose fibres.

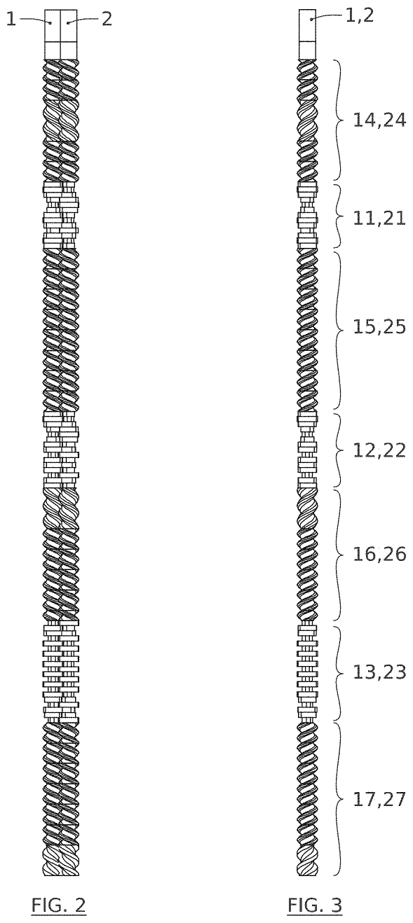

The mechanical treatment 120 is carried out by introduction into a twin-screw extruder of the aqueous suspension of functionalised cellulose fibres by the chemical treatment 110. More particularly, the aqueous suspension of functionalised cellulose fibres is extracted from the reactor wherein the chemical treatment 110 takes place and introduced into a particular hopper located upstream from the inlet of the extruder. In reference to FIGS. 2 and 3, each screw 1, 2 of the extruder bi-vis comprises at least two fibrillation segments 11, 12, 13, 21, 22, 23, and preferably less than nine, even six fibrillation segments. The mechanical treatment 120 is moreover carried out in specific temperature conditions, for example by using a water cooling circuit. More particularly, water circulation channels can be made in the sheath of the extruder. Thus, the twin-screw extruder is maintained at a temperature, less than 60° C., preferably comprised between 0 and 20° C., for example substantially equal to 10° C. Furthermore, the mechanical treatment is carried out with a rotation speed of the screws comprised between 100 and 500 rpm, for example substantially equal to 400 rpm. Using a twin-screw extruder here makes it possible to reduce the energy consumption for the production of cellulose nanofibrils comprised between 5 and 70%, more particularly comprised between 10 and 60%, compared to the mechanical treatments of the current industrial methods. Moreover, although twin-screw extruders allow for and are generally used for mixing the material in transit with at least one reagent injected through the sheath, the mechanical treatment 120 is here preferably advantageously free of any adding of chemical agents.

As shown in FIG. 1, the method of manufacturing according to the invention can comprise other optional steps.

A first of these optional steps comprises a chemical pre-treatment 104. This step of pre-treatment 104 precedes the step of pre-treatment 110. The step of pre-treatment 104 is configured in such a way that the aqueous suspension of cellulose is brought to a pH preferably less than 4, even strictly less than 4, preferably comprised between 3.2 and 3.3. To do this, it comprises the mixture of the aqueous suspension of cellulose fibres with an acid, preferably a sulphuric acid. However, treatment with ozone is operational including when it is carried out on a suspension at a neutral pH or a basic pH.

A second optional step consists of a step of washing 114 the aqueous suspension of functionalised cellulose fibres. This second optional step therefore takes place after the step of chemical treatment 110. It also takes place before the step of mechanical treatment 120. Indeed, once the nanofibrillation is carried out via the mechanical treatment 120, it is no longer possible to perform successive steps of dilution and of concentration that would make it possible to wash the suspension of cellulose micro/nanofibrils produced. The step of washing 114 must therefore be carried out before cellulose micro/nanofibrils are produced, or before the mechanical treatment 120. This step of washing 114 can be necessary, or at the very least recommended, for the purpose of certain target applications, and in particular medical or cosmetics applications. On the contrary, for other target applications, it may be preferable to not implement this step of washing 114. The step of washing 114, when it is implemented, is preferably configured in such a way as to remove, from the aqueous suspension of functionalised cellulose fibres, residues of the functionalising agent used during the chemical treatment 110. It can, furthermore, be configured in such a way as to remove from said suspension other residues, for example coming from the optional step of chemical pre-treatment 104.

The chemical treatment 110 can be followed by and the mechanical treatment 120 can be preceded by an optional step chosen from a step of concentrating 115 or a step of diluting 115′ the aqueous suspension of functionalised cellulose fibres. This step 115, 115′ can be configured in such a way as to obtain a concentration of the aqueous suspension of functionalised cellulose fibres comprised between 10 and 50%, preferably comprised between 10 and 40%, even between 10 and 30%, even between 10 and 20%, and even more preferably substantially equal to 20%, by weight of dry matter at the inlet of the twin-screw extruder. According to an example, the step of washing 114 can precede the step chosen from a step of concentrating 115 or a step of diluting 115′.

The aqueous suspension of functionalised cellulose fibres can have a concentration comprised between 10 and 30%, preferably comprised between 10 and 20%, and even more preferably substantially equal to 20%, by weight of dry matter. It is this suspension of concentration controlled by weight of dry matter that will be introduced at the inlet of the twin-screw extruder. At these controlled concentrations, the transit of the matter through the twin-screw extruder, from the entry thereof to the exit thereof, is satisfactory, in particular in that it causes only little overheating of the material in transit and in that it does not have any risk, or at the least a limited risk, of blocking the matter. A suspension of cellulose micro/nanofibrils is thus obtained at the outlet of the twin-screw extruder that has an equivalent dry matter content, and more particularly equal, to the concentration of the suspension of functionalised cellulose fibres introduced into the twin-screw extruder. At these concentrations, it results in that the method according to the invention has undeniable advantages in terms of production costs, storage costs, transport costs and applications and appears to be a good alternative for the industrialisation of the production of cellulose nanofibrils.

According to a preferred embodiment of the invention, the chemical treatment 110 is configured to functionalise the cellulose fibres at a modification rate higher than 1.3 mmol/g and each screw 1, 2 of the extruder comprises between 3 and 5 fibrillation segments. The method according to this preferred embodiment makes it possible to produce cellulose nanofibrils of quality, with a high dry matter content, and while consuming little energy. Indeed, the inventors observed that, in this preferred embodiment of the invention, the combination of these technical characteristics induces an effect that extends beyond the added effects of each one of these characteristics taken in isolation from one another. There is therefore, in this preferred embodiment of the invention, a synergistic effect that does not seem able to have been foreseen a priori.

In particular, whereas other methods of functionalising cellulose fibres lead to the necessity of implementing the step of mechanical treatment 120 about seven times in a row, the combination of the chemical treatment 110 and of the mechanical treatment 120 such as described hereinabove makes it possible to obtain a suspension of cellulose micro/nanofibrils of quality, right from the first pass of the aqueous suspension of functionalised cellulose fibres in the twin-screw extruder. It is still possible however to consider carrying out several of these passes. In particular, a second pass is not excluded. Obviously, the reduction in the number of passes in the twin-screw extruder contributes to the savings in energy made in such a way that a single pass is from this standpoint preferable to two passes.

FIG. 2 shows the two screws of the laboratory twin-screw extruder inter-penetrated into one another. The two screws shown are identical to each other.

As shown in FIGS. 2 and 3, the fibrillation segments 11, 12, 13, 21, 22, 23 are preferably different from one another. More particularly, they have shearing rates and cumulated deformations that are different from one another. For example, the shearing rates can differ between them by a factor higher than or equal to two. Alternatively, the fibrillation segments can be identical to one another.

Furthermore, each fibrillation segment can comprise a sub-segment with direct screw thread, then a sub-segment with reverse screw thread, arranged relatively with respect to one another from upstream to downstream of the twin-screw extruder, in such a way as to retain the material transiting in the extruder at the fibrillation segment. The transit time of the material at each fibrillation segment is thus advantageously increased, for better nanofibrillation of the functionalised cellulose fibres, at the outlet of said segment.

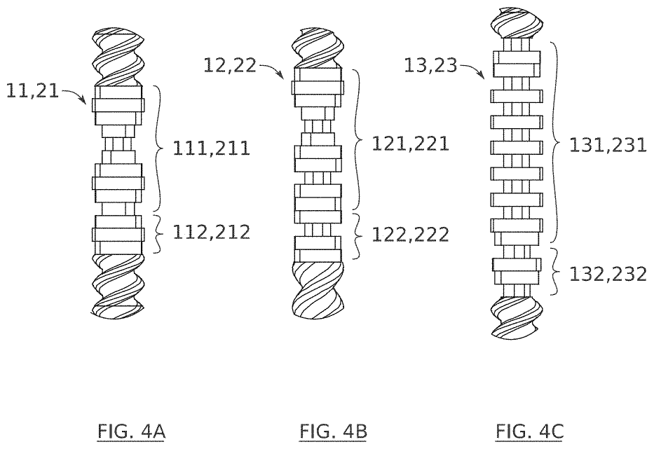

The configuration of each screw such as shown in FIGS. 2 and 3 shows that the three fibrillation segments are different from one another. More particularly, in reference to FIGS. 4A to 4C:
the first fibrillation segment 11, 21 can comprise a first sub-segment 111, 211 comprising ten discs identical to one another and successively arranged together in such a way that two adjacent discs have an angular offset substantially equal to 30°. This first sub-segment 111, 211 can be supplemented with a second sub-segment 112, 212 comprising three additional discs, arranged in such a way as to also have an angular offset substantially equal to 30° two-by-two, but in such a way as to generate a reverse screw thread with respect to the direct screw thread generated by the first sub-segment 111, 211;
the second fibrillation segment 12, 22 can comprise two sub-segments comprising a total of fifteen discs. The first sub-segment 121, 221 comprises the first seven discs arranged in a direct screw thread with an angular offset substantially equal to 30° two-by-two and the four intermediate discs in direct screw thread with an angular offset substantially equal to 60° two-by-two. The second sub-segment 122, 222 comprises the last four discs arranged as a reverse screw thread with an angular offset substantially equal to 60° two-by-two;
the third fibrillation segment 13, 23 can comprise two sub-segments comprising a total of twenty discs. The first sub-segment 131, 231 comprises the first four discs in direct screw thread with an angular offset substantially equal to 60° two-by-two and the twelve intermediate discs arranged as a direct screw thread with an angular offset substantially equal to 90° two-by-two. The second sub-segment 132, 232 comprises the last four discs arranged as a reverse screw thread with an angular offset substantially equal to 60° two-by-two.

Note that such a configuration of the screws today seems incompatible with the use of conical screws.

As shown in FIGS. 2 and 3, each fibrillation segment comprises on either side a conveyor segment 14, 15, 16, 17, 24, 25, 26, 27. The conveyor segments are configured to convey the material transiting in the twin-screw extruder respectuously from the inlet of the extruder to the first fibrillation segment, from the first fibrillation segment to the second fibrillation segment, from the second fibrillation segment to the third fibrillation segment, and from the third fibrillation segment to the outlet of the twin-screw extruder. Each conveyor segment can for example be configured in the form of an endless screw. Moreover, each conveyor segment can be configured to induce, on the material in transit in the twin-screw extruder, a deformation substantially ten times less than the deformation induced by a fibrillation segment.

The step of chemical treatment 110 is more particularly described hereinbelow. It is able to allow for the functionalising of the cellulose fibres of the aqueous suspension with the abovementioned modification rates.

It consists of using, as a functionalising agent, an oxidising agent, and in particular ozone, where applicable in the presence of a catalyst comprising an iron salt, and preferably an iron sulphate. This is an ozonation reaction. The cellulose fibres are then functionalised by grafting of carbonyls. The use of a catalyst, and in particular of an iron salt, makes it possible to increase the modification rate of the cellulose fibres during the chemical treatment 110 and thus makes it possible to further reduce the energy consumed during the subsequent step of mechanical treatment 120 and to increase the quality of the suspensions of cellulose micro/nanofibrils obtained thanks to the method according to the invention. More particularly, the ozone is mixed with the aqueous suspension of cellulose at a concentration in ozone comprised between 10 and 35%, preferably comprised between 10 and 15%, by weight of the weight in dry matter of cellulose; and where applicable, the iron salt is present at a concentration comprised between 0.01 and 5%, preferably comprised between 0.02 and 3%, by weight of the weight in dry matter of cellulose. Typically, the aqueous suspension of cellulose fibres then has, before the chemical treatment 110, a concentration substantially equal to 40% in dry matter. The chemical treatment 110 is thus carried out on a suspension with a high concentration in dry matter which makes it possible to limit the consumption of water. In addition, ozone is a hardly toxic and inexpensive product, the use thereof allows for a decrease in hazardous chemical waste, and ozonation is a process that is available industrially. In particular, ozone can be produced in an ozone generator, then injected (in a mixture with oxygen), by means of a pipe, into the reactor where the chemical treatment 110 takes place. The time required for the chemical treatment 110 is governed by the flow rate of ozone injected into the reactor.

The chemical treatment 110 according to the invention being carried out from a suspension at a concentration of 5% or 50%, even 40% in dry matter represents alone a gain in productivity, due to the fact that the industrial methods currently implemented are carried out from suspensions at a concentration of 2% in dry matter.

An embodiment of the method according to the invention is described hereinbelow.

According to this example, an aqueous suspension of cellulose fibres at 40% by weight of dry matter is mixed with ozone at a concentration comprised between 10 and 25%, preferably comprised between 11 and 18%, by weight with respect to the weight in fibre dry matter, and with a catalyst FeSO4 with a concentration comprised between 0.01 and 5%, preferably comprised between 0.01 and 2%, by weight with respect to the weight in fibre dry matter. The chemical treatment 110 is configured in such a way as to obtain a modification rate higher than 1.0 mmol/g, preferably higher than 1.3 mmol/g. Following the chemical treatment 110, the aqueous suspension of cellulose fibres is washed 114, then diluted in such a way that its concentration is comprised between 10 and 30%, and preferably comprised between 15 and 20%, by weight of dry matter. The aqueous suspension of cellulose fibres thus obtained is inserted into a twin-screw extruder comprising between three and five fibrillation segments with sub-segments with a reverse screw thread, by being maintained at a temperature comprised between 0 and 20° C., and a rotation speed of the screws comprised between 100 and 500 rpm. The reduction in energy consumed is then substantially equal to 20% with respect to a conventional enzymatic treatment.

The invention is not limited to the embodiments described hereinabove and extends to all embodiments covered by the claims.

The twin-screw extruder described hereinabove is more a laboratory extruder developed to prove the feasibility of the method according to the invention and to show what it makes possible to obtain, rather than an industrial extruder. In particular, an industrial extruder may not comprise sub-segments to be assembled together to form in particular a fibrillation segment, but rather comprises an alternation of conveyor and fibrillation segments, for example not movable between them, the conveyor segments having a direct screw thread and the fibrillation segments having a reverse screw thread. Alternatively or in addition, the conveyor segments with direct screw thread can be arranged on either side of each fibrillation segment. An industrial extruder that can be used to implement the method according to the invention is for example the one developed and marketed by the company Clextral under reference BC-21.

Moreover, the chemical treatment and the mechanical treatment are described hereinabove as being successive. This may not be the case. Alternatively or in addition, it is considered that ozone be injected directly into the extruder while the aqueous suspension of cellulose fibres is itself in transit therein. The chemical treatment and the mechanical treatment are then at least partially concomitant together.

The aqueous suspension of cellulose fibres, prior to and/or during the chemical treatment, even the aqueous suspension of functionalised cellulose fibres, can have a concentration higher than 10%, even higher than 20%, even higher than 30% by weight of dry matter. Additionally or alternatively, this concentration can be less than 50%, even less than 40% by weight of dry matter. The suspension of cellulose fibres, of concentration controlled by weight of dry matter can be introduced at the inlet of the twin-screw extruder.

The aqueous suspension of cellulose fibres, in particular functionalised, can have a concentration higher than 10%, even higher than 20%, even higher than 30% by weight of dry matter, at the inlet of the twin-screw extruder. Additionally or alternatively, this concentration can be less than 50%, even less than 40% by weight of dry matter. The aqueous suspension of cellulose fibres, in particular functionalised, can have a concentration comprised between 10 and 50%, preferably comprised between 20 and 40%, and even more preferably between 30% and 40% by weight of dry matter at the inlet of the twin-screw extruder. The higher this concentration is, the more limited the water content is and the more satisfactory the concentration in dry matter at the outlet of the twin-screw extruder is, in particular in terms of transport efficiency, but also in terms of possibilities for industrial post-treatment. A concentration of the suspension higher than 20% facilitates the mechanical treatment in the twin-screw extruder. The maximum values of this concentration make it possible to limit overheating of the material and a possible risk of blocking of the material, during the transit thereof in the extruder. The lower the maximum values are, the more limited this overheating of the material and this possible risk of blocking are.

The twin-screw extruder, and more particularly the sheath can be maintained at a temperature less than 60° C., preferably comprised between 10 and 30° C., even between 10 and 20° C., for example substantially equal to 20° C. The mechanical treatment can be carried out with a rotation speed of the screws comprised preferably between 100 and 1200 rpm.

The suspension obtained after the mechanical treatment can have a concentration comprised between 10 and 50%, preferably comprised between 10 and 40%, even comprised between 20 and 40% by weight of dry matter.

The method can furthermore be free from a step of drying between the chemical treatment 110 and the mechanical treatment 120. More particularly, the method can furthermore be free from a step of drying through which the proportion in water of the aqueous suspension of functionalised cellulose fibres would be reduced in order to be less than 30%, even less than 20%, by weight with respect to the total weight of the suspension. Equivalently, the method can comprise a step of drying through which the proportion in water of the aqueous suspension of functionalised cellulose fibres remains higher than 20%, even higher than 30%, by weight with respect to the total weight of the suspension, from the chemical treatment 110 to the mechanical treatment 120.

Prior to the chemical treatment 110, the method can be exempt from a pre-treatment of the cellulose fibres by carboxymethylation. Thus, the method is simplified while still limiting the deterioration of the cellulose fibres that can be caused by an additional pre-treatment.

1. A method for manufacturing a suspension of cellulose micro/nanofibrils from an aqueous suspension of cellulose fibres comprising the following steps:
performing a chemical treatment of the aqueous suspension of cellulose fibres by at least one functionalizing agent, the chemical treatment being configured to functionalise the cellulose fibres at a modification rate that is higher than 1.0 mmol/g, and
performing a mechanical treatment, by a twin-screw extruder, of the aqueous suspension of cellulose fibres, each screw of the extruder comprising at least two fibrillation segments,
wherein the functionalizing agent comprises ozone.

2. The method according to claim 1, wherein the chemical treatment is configured to functionalize the cellulose fibres at a modification rate comprised between 1.0 mmol/g and 3.0 mmol/g.

3. The method according to claim 1, wherein each screw of the extruder comprises between 2 and 6 fibrillation segments.

4. The method according to claim 1, wherein the mechanical treatment comprises at most two passes of the aqueous suspension of functionalized cellulose fibres in the twin-screw extruder.

5. The method according to claim 1, wherein the chemical treatment is followed by and the mechanical treatment is preceded by a step chosen from a step of concentrating or a step of diluting the aqueous suspension of functionalized cellulose fibres, this step being configured in such a way as to obtain a concentration of the aqueous suspension of functionalised cellulose fibres comprised between 10 and 50% by weight of dry matter at the inlet of the twin-screw extruder.

6. The method according to claim 1, wherein the chemical treatment is followed by and the mechanical treatment is preceded by a step of washing the aqueous suspension of cellulose fibres, the step of washing being configured in such a way as to remove from the aqueous suspension of functionalized cellulose fibres residues of the functionalizing agent.

7. The method according to claim 5, wherein the chemical treatment is followed by and the mechanical treatment is preceded by a step of washing the aqueous suspension of cellulose fibres, the step of washing being configured in such a way as to remove from the aqueous suspension of functionalized cellulose fibres residues of the functionalizing agent, and the step of washing precedes the step chosen from a step of concentrating or a step of diluting.

8. The method according to claim 1, wherein at least two fibrillation segments of each screw of the extruder bi-vis are configured to generate shearing rates and cumulated deformations that are different from one another.

9. The method according to claim 1, wherein the screws of the extruder comprise a conveyor segment on at least one side of each fibrillation segment.

10. The method according to claim 1, wherein at least one fibrillation segment of at least one of the two screws comprises at least one among a portion with a direct screw thread and a portion with a reverse screw thread.

11. The method according to claim 1, wherein the ozone is mixed with the aqueous suspension of cellulose fibres at a concentration comprised between 10 and 35% by weight of the weight in dry matter of cellulose, the modification rate being higher than 1.2 mmol/g.

12. The method according to claim 1, wherein the chemical treatment with ozone is carried out in the presence of a catalyst comprising an iron salt at a concentration comprised between 0.01 and 5% by weight of the weight in dry matter of cellulose.

13. The method according to claim 1, wherein, before the chemical treatment, the aqueous suspension of cellulose fibres has a concentration substantially equal to 40% in dry matter.

14. The method according to claim 1, comprising, before the chemical treatment, a chemical pre-treatment comprising the mixing of the aqueous suspension of cellulose fibres with an acid, the chemical pre-treatment being configured so that the aqueous suspension of cellulose fibres has a pH strictly less than 4.

15. The method according to claim 1, wherein the step of chemical treatment precedes the step of mechanical treatment and is carried out in a reactor, the cellulose fibres being functionalized before the step of mechanical treatment.
